(19) United States
(12) Patent Application Publication
(10) Pub. No.: US 2007/0267862 A1
(43) Pub. Date: Nov. 22, 2007

(54) CARD HOLDING ASSEMBLY AND BLANK

(76) Inventor: Kelly Maculan Barr, Riverside, IL (US)

Correspondence Address: WALLENSTEIN & WAGNER, LTD., 311 SOUTH WACKER DRIVE, 53RD FLOOR, CHICAGO, IL, 60606, US

(21) Appl. No.: 11/419,386

(22) Filed: May 19, 2006

(51) Int. Cl. B42D 15/00

(52) U.S. Cl. 283/61

(57) ABSTRACT

A blank is provided for a card holding assembly formed from a single sheet of material. The blank includes a substantially continuous and uninterrupted first panel having a first length. The blank also includes a substantially continuous and uninterrupted second panel having a second width. The second panel is separated from the first panel by a first score line and a second score line disposed adjacent the second panel. The first and second score lines define a first thickness. The blank further includes a third panel having a third width and the third panel is separated from the second panel by a third score line and a fourth score line disposed adjacent the second panel. The third and fourth score lines define a second thickness which is less than the first thickness. The third panel comprises a cut-out window. The third width is less than the first and second lengths. The blank also includes first and second tabs extending from the opposite sides of the third panel. The blank has an adhesive disposed between both the first tab and the second panel and the second tab and the second panel. The adhesive is provided for adhering the second panel to the third panel to form a pocket. The blank finally includes a transparent material covering the cut-out window and disposed between the second panel and the third panel.

### CROSS-REFERENCE TO RELATED APPLICATIONS

None

### FEDERALLY SPONSORED RESEARCH OR DEVELOPMENT

None

### TECHNICAL FIELD

The invention relates to a card holding assembly, and more specifically to a card holding assembly with at least one cut-out window.

### BACKGROUND OF THE INVENTION

Cards such as gift cards and debit cards are sold to consumers by retailers. These cards typically have a predetermined dollar amount encoded on the card which may be used only at a particular retail or commercial store. These cards may be distributed via the mail, in person or through point-of-sale purchase at a store.

Card holding assemblies are typically formed from folded paper blanks suitable for holding a card inside the folded blank. A consumer or gift recipient opens the folded paper to reveal the card. Card holding assemblies also include use of a plastic window to cover the card. Often card holding assemblies open prematurely because the folded paper unfolds. A need exists for a card holding assembly that maintains in the folded position until opened. A need also exists to form a pocket smaller than the first cover panel of material for easy insertion of the card into the card holding assembly.

The present invention is provided to solve the problems discussed above and other problems, and to provide advantages and aspects not provided by prior card holding assemblies of this type. A full discussion of the features and advantages of the present invention is deferred to the following detailed description, which proceeds with reference to the accompanying drawings.

### SUMMARY OF THE INVENTION

According to the present invention, a card holding assembly is provided. The card holding assembly has an open and a closed position. In the open position, a card is visible through a cut-out window in one of the panels of the assembly. In the closed position, the card is not visible because a continuous and uninterrupted cover panel conceals the card.

In accordance with one embodiment of the present invention, a blank for a card holding assembly is provided. The blank includes a substantially continuous and uninterrupted first and second panels. The first panel has a first length and a first width, and the second panel has a second length and a second width. The second panel is separated from the first panel by a first score line and a second score line disposed adjacent the top portion of the second panel. The first and second score lines define a first thickness. The second width is substantially the same as the first width and the second length is substantially the same as the first length. The blank further includes a third panel that includes a third length and a third width. The third panel is separated from the second panel by a third score line and a fourth score line disposed adjacent the bottom portion of the second panel. The third panel includes a cut-out window. The third and fourth score lines define a second thickness. The third width is substantially the same as the second width and the third length is less than the second length.

The blank also includes first and second tabs. The first tab is disposed adjacent to the fourth score line and extends from the third panel. The second tab is disposed adjacent to the fourth score line and extends from a side of the third panel opposite the first tab. The blank includes an adhesive disposed between both the first tab and the second panel and the second tab and the second panel. The adhesive is provided for adhering the second panel to the third panel to form a pocket. The blank also has a transparent material covering the cut-out window and disposed between the second panel and the third panel. The first panel is selectively foldable over the pocket to form the closed position of the card holding assembly. The first thickness is greater than the second thickness.

In accordance with another aspect of the present invention, a card holding assembly is provided. The card holding assembly includes a first panel, a second panel, a third panel, a fourth panel, first and second tabs, an adhesive, first and second sheets of transparent material and a card. The first panel is a substantially continuous and uninterrupted first panel. The second panel is also substantially continuous and uninterrupted. The second panel is separated from the first panel by a first score line and a second score line disposed adjacent the top portion of the second panel. The third panel is separated from the second panel by a third score line and a fourth score line disposed adjacent either the left portion or the right portion of the second panel. The third panel includes a first cut-out window. The fourth panel is separated from the third panel by a fifth score line and a sixth score line disposed adjacent either the top portion or the bottom portion of the third panel. The fourth panel includes a second cut-out window. All of the first length, second length, third length and fourth length are substantially the same. All of the first width, second width, third width and fourth width are substantially the same. The first cut-out window and second cut-out window are substantially the same dimensions. The first and second trapezoidal tabs extend from the fourth panel.

The first and second tabs are disposed on adjacent sides of the fourth panel. The adhesive is disposed between both the first tab and the third panel and the second tab and the third panel. The adhesive is provided for adhering the fourth panel to the third panel to form a pocket. The pocket is provided for receiving a card. The first sheet of transparent material is wider and longer than the first cut-out window and the second sheet of transparent material is wider and longer than the second cut-out window. The first sheet of transparent material is affixed to an exterior of the first cut-out window and disposed between the fourth panel and the third panel, and the second sheet of transparent material is affixed to an interior of the second cut-out window and disposed between the fourth panel and the third panel. The card holding assembly also includes a card disposable within the pocket. The card is visible through either the first cut-out window and first sheet of transparent material or the second cut-out window and the second sheet of transparent material when the card holding assembly is in the open position. The first panel conceals the card when the card holding assembly is in the closed position.

In accordance with yet another aspect of the present invention, a method of forming a card holding assembly is provided. The method includes providing a blank. The blank is scored at a first predetermined location to form a first score line. The first predetermined location is a first distance from an end of the blank. The blank is also scored at a second predetermined location to form a second score line. The second predetermined location is a second distance from the first predetermined location. The blank is scored at a third predetermined location to form a third score line. The third predetermined location is the first distance from the second predetermined location. The blank is further scored at a fourth predetermined location to form a fourth score line. The fourth predetermined location is approximately half of the second distance from the third predetermined location. The method also includes forming a card holding assembly from scored blank. Finally, the method includes printing at least one of a text or an image on at least one surface of the first panel.

A further aspect of the present invention is a card holding assembly. The card holding assembly includes a substantially continuous and uninterrupted first sheet having a first length and a first width. The card holding assembly also includes a second sheet having a first layer and a second layer. The first layer is substantially continuous and uninterrupted and has a second length, a second width and a top portion. The second length and the second width are substantially the same as the first length and the first width. The second sheet is separated from the first sheet by a first score line and a second score line disposed adjacent the top portion of the first layer. The second layer has a third length and a third width and the second layer comprises a cut-out window and a transparent material covering the cut-out window. The third length is less than the second length. The first and second layers are adhered to each other on at least two sides to form a pocket. The first sheet is selectively foldable over the pocket to form the closed position of the card holding assembly.

Other features and advantages of the invention will be apparent from the following specification taken in conjunction with the following drawings.

### BRIEF DESCRIPTION OF THE DRAWINGS

To understand the present invention, it will now be described by way of example, with reference to the accompanying drawings in which:

FIG. 1 is a top view of a blank for of forming a card holding assembly in accordance with one embodiment of the present invention;

FIG. 2 is a perspective view of card holding assembly formed from the blank of FIG. 1;

FIG. 3 is a top view of a card holding assembly in accordance with another embodiment of the present invention; and,

FIG. 4 is a perspective view of the card holding assembly of FIG. 2.

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

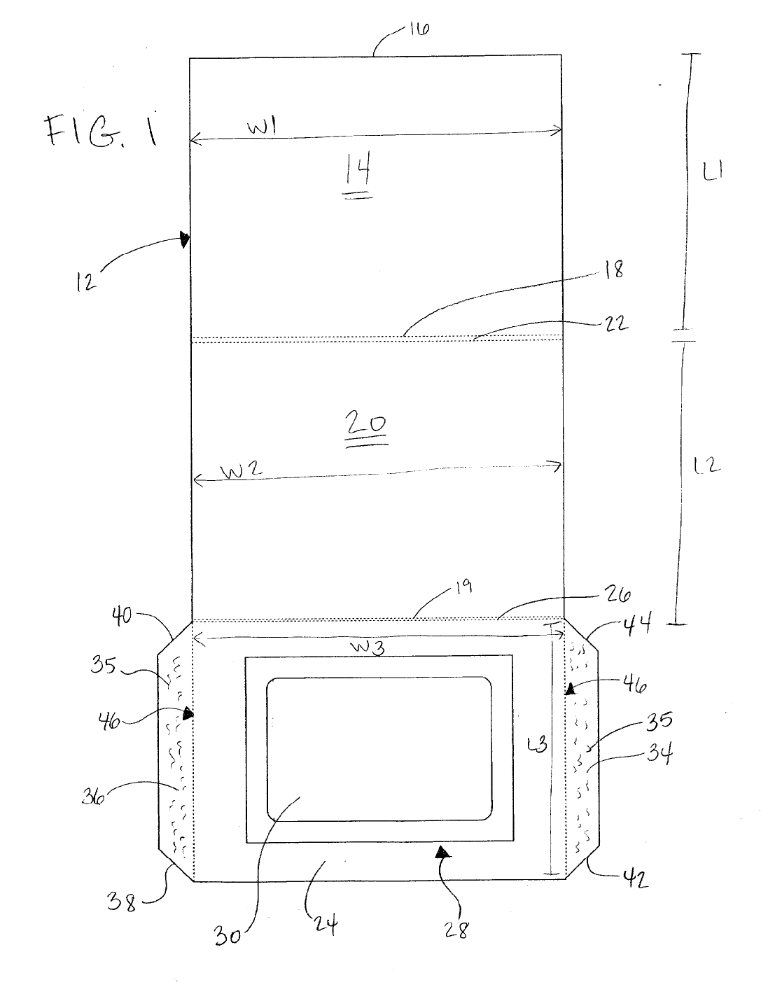

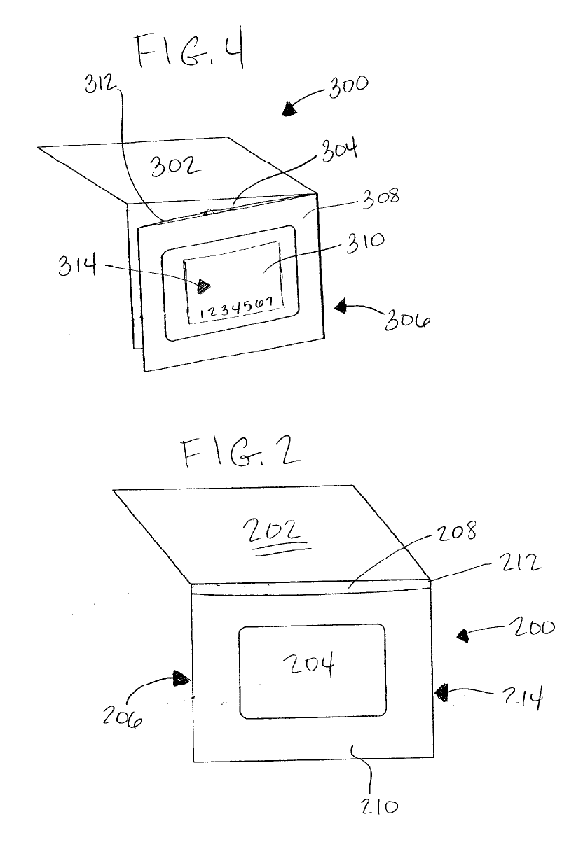

As shown in FIG. 1, a blank 12 is provided. The blank 12 is preferably formed from a single sheet of material such as cardstock or plastic. In one embodiment, blank 12 is utilized to form a card holding assembly, including for example, a eighty pound cardstock assembly with a printed message and a gift card from a retailer. The card holding assembly formed from the blank 12 has an open position and a closed position. As shown in FIG. 2, the open position permits a customer to view a card with the card holding assembly and to read various text, indicia or card information. In the closed position, a customer cannot view the card because it is concealed by a panel of the assembly. A customer can read any text or indicia on the outside of the panel in the closed position, but cannot view the card itself.

The blank 12 includes a first panel 14, a second panel 20, a third panel 24, first and second tabs 34 and 36, and transparent material 28. For various reasons, additional panels may be used for a second or third card or inserts to the assembly.

As shown in FIG. 1, in one embodiment the first panel 14 is generally rectangular and substantially continuous and uninterrupted. First panel 14 does not contain any large holes, windows, gaps or other interruptions. As will be understood by those of skill in the art, a panel is substantially continuous and uninterrupted even if it contains score lines. The first panel 14 has a first width W1 and a first length L1. In one embodiment, W1 is 5.5 inches and L1 is 4.125 inches. The first panel may include text, either on the inside or outside surface.

Like the first panel 14, the second panel 20 in one embodiment is generally rectangular and substantially continuous and uninterrupted. The second panel has a top portion 18, a bottom portion 19, a second length L2 and a second width W2. In one embodiment, W2 is 5.5 inches and L2 is 4.125 inches. The second panel 20 is separated from the first panel 14 by a first score line 21 and a second score line 22. The first score line 21 and second score line 22 are substantially straight, parallel to each other and disposed adjacent to the top portion 18 of the second panel 20. The first score line 21 and second score line 22 together define a first thickness. In one embodiment of the first thickness is 0.0625 inches. In one embodiment, the second width W2 is substantially the same as the first width W1, and the second length L2 is substantially the same as the first length L1.

The third panel 24 has a third length L3 and a third width W3. In one embodiment, the third width W3 is 5.5 inches and the third length L3 is 3.875 inches. Thus, the first width W1, second width W2 and third width W3 are substantially the same. However, the third length L3 is smaller than the first and second lengths L1 and L2. In one embodiment, the third length L3 is greater than 80% of the second length L2, and more preferably is approximately 94% of the second length. The reduced length of the third panel facilitates easy insertion of a card into the pocket. The third panel may include indicia indicating or referring to information about the card.

The third panel 24 is separated from the second panel 20 by a third score line 19 and fourth score line 26. The third score line 19 and fourth score line 26 are disposed adjacent the bottom portion 19 of the second panel 20. In one embodiment, the third score line 19 and fourth score line 26 together define a second thickness. In one embodiment, the second thickness is 0.03125 inches. The third panel 24 also has a cut-out window 30. The cut-out window 30 is generally rectangular and may have rounded edges. In one embodiment, the cut-out window 30 has a length greater than 50% of the third length L3. The length of the cut-out window may be 2.375 inches. The cut-out window 30 may have a width greater than 50% of the third width W3, and in one embodiment, the length of the cut-out window may be 3.325 inches.

The first thickness is greater than the second thickness. The first thickness forms a fold line in the assembled card holder. The first thickness permits the assembly to close over all sheets of the assembly, including both the second panel 20 and the third panel 24. In one embodiment, the first thickness is at least 50% larger than the second thickness, and more preferably is 200% larger than the second thickness.

The first tab 34 is disposed adjacent to the third score line 19 and the fourth score line 26 and extends from the third panel 24. The second tab 36 is disposed adjacent to the third score line 19 and the fourth score line 26 and extends from a side of the third panel 24 opposite the first tab 34. In one embodiment, first tab 34 is separated from third panel 24 by fifth score line 52 and second tab 36 is separated from third panel 24 by sixth score line 51. During assembly, the first and second tabs 34 and 36 are folded inward toward the third panel 24 along fifth score line 52 and sixth score line 51. The first and second tabs 34 and 36 may be generally trapezoidal in shape. Tapered portions 38, 40, 42 and 44 reduce any hangover from tabs 34 and 36 in the assembled product.

An adhesive 35 is disposed between both the first tab 34 and the second panel 20 and the second tab 36 and the second panel 20. In one embodiment, the adhesive 35 is disposed on the first tab 34 and the second tab 36. The adhesive 35 may be in any pattern including for example, a thin strip. The adhesive 35 is provided for adhering the second panel 20 to the third panel 24 to form a pocket. The pocket is provided for receiving a card and always remains unsealed at least sufficient to permit insertion and removal of a card. A card is typically approximately 3.375 inches long and 2.125 inches wide. The pocket may position the card such that it is entirely viewable through the cut-out window 30 and transparent material 28.

The first panel 20 is selectively foldable over the pocket to form the closed position of the card holding assembly. As will be understood by those of skill in the art, the pocket is provided for receiving a card in a widthwise direction. As such, the card is inserted into the pocket via the wider portion of the card.

The transparent material 28 covers the cut-out window 30 and permits a user to see through cut-out window 30. The transparent material 28 is typically plastic or polyvinyl and protects any objects placed in the pocket from being touched, and is slightly larger in both length and width than the cut-out window 30. While the transparent material 28 is shown as being rectangular, it will be understood by those of skill in the art that transparent material 28 may be of any size or shape so long as it covers cut-out window 30. In one embodiment, the transparent material 28 has a length of 2.75 inches and a width of 3.95 inches. The transparent material 28 is disposed between the second panel 20 and the third panel 24.

In FIG. 2, a card holding assembly 200 is illustrated. The card holding assembly 200 may be formed from the blank 12 previously described. The card holding assembly 200 is formed from a single sheet of material and has an open position and a closed position.

The card holding assembly 200 includes a substantially continuous and uninterrupted first sheet 202 and a second sheet 206. The second sheet 206 has a first layer 208 and a second layer 210. The first layer 208 is substantially continuous and uninterrupted and a top portion. The dimensions of the first layer 208 are substantially the same as the dimensions of the first sheet 202. The second sheet 206 is separated from the first sheet 202 by a first score line 212 disposed adjacent the top portion of the first layer 208. The second layer 210 includes a cut-out window 204 and a transparent material 214 covering the cut-out window 204. The length of the second layer 210 is less than the length of the first layer 208. The first and second layers 206 and 208 are adhered to each other on at least two sides to form a pocket 214, and preferably on all of both sides. The first sheet 206 is selectively foldable over the pocket 214 to form the closed position of the card holding assembly 200. In one embodiment, the pocket 214 is closed on three sides, two of which are adhered together and the third formed by a score line. Those of skill in the art understand that the pocket 214 may be formed other than being closed on three sides.

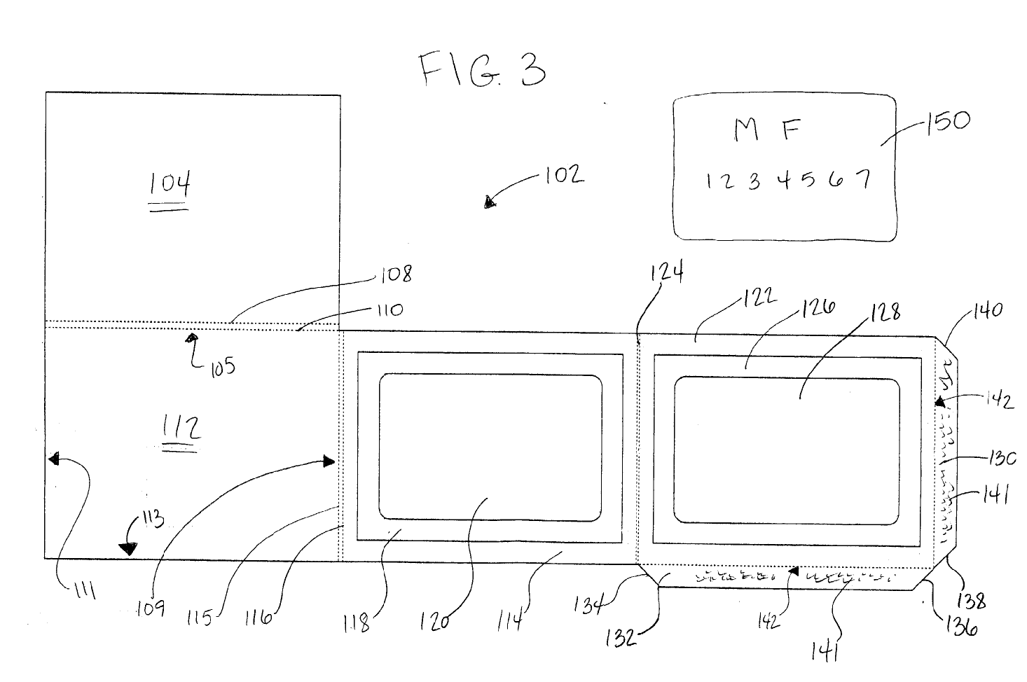

Turning now to FIG. 3, another embodiment of the present invention is shown. A card holding assembly 102 is shown. Card holding assembly 102 may be formed from a single sheet of material. Card holding assembly 102 has an open position and a closed position. Card holding assembly 102 includes a first panel 104, second panel 112, third panel 114, fourth panel 122, first and second trapezoidal tabs 130 and 132, an adhesive 141, a first and second sheet of transparent material 118 and 126 and a card 150.

The first panel 104 is generally rectangular and is substantially continuous and uninterrupted. The first panel has a first length and a first width of 3.375 inches and 4.375 inches respectively.

The second panel 112 is also generally rectangular and is substantially continuous and uninterrupted. The second panel 112 has a top portion 105, a bottom portion 113, left portion 111 and right portion 109, a second length and a second width. The second panel 112 is separated from the first panel 104 by a first score line 108 and second score line 110 disposed adjacent the top portion 105 of the second panel.

The third panel 114 has a top portion, a bottom portion, a third length and a third width. The third panel 114 is separated from the second panel 112 by a third score line 115 and a fourth score line 116 disposed adjacent either the left portion 111 or the right portion 109 of the second panel 112. The third panel 114 has a first cut-out window 120. In one embodiment, the cut-out window 120 is in the center of the third panel 114.

The fourth panel 122 has a fourth length and a fourth width. The fourth panel 122 is separated from the third panel 114 by a fifth score line 123 and a sixth score line 124 disposed adjacent either the top portion or the bottom portion of the third panel 114. The fourth panel 122 includes a second cut-out window 128. In one embodiment, all of the first length, second length, third length and fourth length are substantially the same, wherein all of the first width, second width, third width and fourth width are substantially the same, and wherein the first cut-out window 120 and second cut-out window 128 are substantially the same dimensions. In one embodiment, the cut-out window 128 is in the center of the fourth panel 122.

The first and second trapezoidal tabs 130 and 132 extend from the fourth panel 122. The first and second tabs 130 and 132 are disposed on adjacent sides of the fourth panel 122. In one embodiment, first and second tabs 130 and 132 are separated from fourth panel 122 by score lines 142.

The adhesive 141 is disposed between both the first tab 130 and the third panel 114 and the second tab 132 and the third panel 114. The adhesive 141 is provided for adhering the fourth panel 122 to the third panel 114 to form a pocket. The pocket is provided for receiving the card in a lengthwise direction. In one embodiment, the adhesive 141 is disposed on first and second tabs 130 and 132 in the form of a glue strip. The pocket is provided for receiving the card 150.

The first and second sheets 118 and 126 of transparent material are used to permit a viewer to see the card 150. Both the first sheet 118 of transparent material and the second sheet 126 of transparent material are wider and longer than the first cut-out window 120 and second cut-out window 128 respectively. The first sheet 118 and second sheet 126 may be identical in dimensions and shape, or then may be different, as long as both cover their respective cut-out windows. The first sheet 118 of transparent material is affixed to an exterior of the first cut-out window 120 and disposed between the fourth panel 122 and the third panel 114. The second sheet 126 of transparent material is affixed to an interior of the second cut-out window 128 and disposed between the fourth panel 122 and the third panel 114.

The card 150 is disposable within the pocket. The card may be a gift card, or other card such as a credit card, debit card or identification card. The card typically is 3.375 inches long and 2.125 inches wide, although it will be understood that these dimensions can be varied without departing from the present invention. The card 150 is visible on one side through the first cut-out window 120 and first sheet of transparent material 118. The card 150 is visible on its other side through the second cut-out window 128 and the second sheet 126 of transparent material when the card holding assembly is in the open position. The first panel 104 conceals the card 150 when the card holding assembly is in the closed position.

In FIG. 4, a card holding assembly 300 is illustrated. The card holding assembly 300 is formed from a single sheet of material and has an open position and a closed position. The card holding assembly 300 has a first sheet 302, a second sheet 304 and a third sheet 306. Third sheet 306 has two layers 308 and 312. First sheet 302 is substantially uninterrupted and continuous and is capable of folding to close card holding assembly 300. Second sheet 304 is also substantially uninterrupted and continuous. Both first sheet 302 and second sheet 304 may contain various text or indicia. Third sheet 306 contains a pocket formed by two layers 308 and 312. The pocket is capable of containing a card 314. Card 314 is visible through cut-out window 310 which is present in both layers 308 and 312. Although first sheet 302, second sheet 304 and third sheet 306 are illustrated as rectangular in shape, they can be other shapes such as a square, circle or hexagon. In one embodiment, first sheet 302, second sheet 304 and third sheet 306 have identical outer dimensions.

The present invention also includes a method of forming a card holding assembly. The method comprises providing a blank, scoring the blank at a first predetermined location, scoring the blank at a second predetermined location, scoring the blank at a third predetermined location, scoring the blank at a fourth predetermined location, forming a card holding assembly and printing.

Describing the method in more detail, a blank is provided. The blank may be a sheet of material such as eighty pound cardstock, including for example, a web of material. The blank is scored at a first predetermined location to form a first score line. The first predetermined location being a first distance from an end of the blank. The blank is scored at a second predetermined location to form a second score line. The second predetermined location is a second distance from the first predetermined location. The blank is scored at a third predetermined location to form a third score line. The third predetermined location is the first distance from the second predetermined location. The blank is also scored at a fourth predetermined location to form a fourth score line. The fourth predetermined location is approximately half of the second distance from the third predetermined location. The score lines may be formed in any order, including for example, with the first score line being formed first, the second score line being formed second, the third score line being formed third and the fourth score line being formed last (or in reverse order).

A card holding assembly is formed from the blank with the first and second score lines. The card holding assembly includes a substantially continuous and uninterrupted first panel, a substantially continuous and uninterrupted second panel separated from the first panel by the first score line disposed adjacent a top portion of the second panel. The first and the second panels are of substantially the same dimensions. The second panel may be hinged or otherwise affixed to the third panel. In one embodiment, the second panel is coupled to the third panel by an adhesive strip.

The card holding assembly also includes a third panel separated from the second panel by the second score line disposed adjacent a bottom portion of the second panel. The third panel comprises a cut-out window. The third panel and the second panel are coupled to form a pocket provided for receiving a card.

The method further includes printing at least one of a text or an image on at least one surface of the first panel. Text such as poetry may be printed on the outside of the first panel. Alternatively or in combination, an image of a flower or other ornamental object is printed on the outside or inside of the first panel.

The method optionally includes folding the first panel over the second panel and folding the third panel over the second panel.

While the specific embodiments have been illustrated and described, numerous modifications come to mind without significantly departing from the spirit of the invention, and the scope of protection is only limited by the scope of the accompanying Claims.

1. A blank for a card holding assembly formed from a single sheet of material and having an open position and a closed position, the blank comprising:
a substantially continuous and uninterrupted first panel having a first length and a first width;
a substantially continuous and uninterrupted second panel having a top portion, a bottom portion, a second length and a second width, wherein the second panel is separated from the first panel by a first score line and a second score line disposed adjacent the top portion of the second panel, wherein the first and second score lines define a first thickness, and wherein the second width is substantially the same as the first width and the second length is substantially the same as the first length;
a third panel having a third length and a third width, wherein the third panel is separated from the second panel by a third score line and a fourth score line disposed adjacent the bottom portion of the second panel, the third panel comprising a cut-out window, wherein the third and fourth score lines define a second thickness, and wherein the third width is substantially the same as the second width and the third length is less than the second length;
first and second tabs, the first tab being disposed adjacent to the fourth score line and extending from the third panel, and the second tab being disposed adjacent to the fourth score line and extending from a side of the third panel opposite the first tab;
an adhesive disposed between both the first tab and the second panel and the second tab and the second panel, wherein the adhesive is provided for adhering the second panel to the third panel to form a pocket, wherein the pocket is provided for receiving a card; and
a transparent material covering the cut-out window and disposed between the second panel and the third panel, wherein the first panel is selectively foldable over the pocket to form the closed position of the card holding assembly, and wherein the first thickness is greater than the second thickness.

2. The blank for the card holding assembly of claim 1 wherein the third length is greater than 80% of the second length.

3. The blank for the card holding assembly of claim 1 wherein the third length is approximately 94% of the second length.

4. The blank for the card holding assembly of claim 1 wherein the first thickness is more than 50% the second thickness.

5. The blank for the card holding assembly of claim 1 wherein the first thickness is approximately 200% of the second thickness.

6. The blank for the card holding assembly of claim 1 further comprising text on at least one surface of the first panel.

7. The blank for the card holding assembly of claim 1 further comprising card indicia on at least one surface of the third panel.

8. The blank for the card holding assembly of claim 1 wherein the cut-out window has a length greater than 50% of the third length and a width greater than 50% of the third width.

9. The blank for the card holding assembly of claim 1 wherein the cut-out window is approximately 3.375 inches long and 2.125 inches wide.

10. The blank for the card holding assembly of claim 1 wherein the first and second tabs are generally trapezoidal in shape.

11. The blank for the card holding assembly of claim 1 wherein the first and second tabs are provided for folding inward toward the third panel.

12. The blank for the card holding assembly of claim 1 wherein the first tab is separated from the third panel by a fifth score line and the second tab is separated from the third panel by a sixth score line.

13. The blank for the card holding assembly of claim 1 wherein the adhesive is in the form of a strip disposed on the first and second tabs.

14. The blank for the card holding assembly of claim 1 wherein the pocket is provided for receiving a card in a widthwise direction.

15. A card holding assembly formed from a single sheet of material and having an open position and a closed position, the card holding assembly comprising:
a substantially continuous and uninterrupted first panel having a first length and a first width;
a substantially continuous and uninterrupted second panel having a top portion, a bottom portion, left portion and right portion, a second length and a second width, wherein the second panel is separated from the first panel by a first score line and a second score line disposed adjacent the top portion of the second panel;
a third panel having a top portion, a bottom portion, a third length and a third width, wherein the third panel is separated from the second panel by a third score line and a fourth score line disposed adjacent either the left portion or the right portion of the second panel, the third panel comprising a first cut-out window;
a fourth panel having a fourth length and a fourth width, wherein the fourth panel is separated from the third panel by a fifth score line and a sixth score line disposed adjacent either the top portion or the bottom portion of the third panel, the fourth panel comprising a second cut-out window, wherein all of the first length, second length, third length and fourth length are substantially the same, wherein all of the first width, second width, third width and fourth width are substantially the same, and wherein the first cut-out window and second cut-out window are substantially the same dimensions;
first and second trapezoidal tabs extending from the fourth panel, the first and second tabs being disposed on adjacent sides of the fourth panel;
an adhesive disposed between both the first tab and the third panel and the second tab and the third panel, wherein the adhesive is provided for adhering the fourth panel to the third panel to form a pocket, wherein the pocket is provided for receiving a card; and
a first and second sheet of transparent material, wherein the first sheet of transparent material is wider and longer than the first cut-out window and the second sheet of transparent material is wider and longer than the second cut-out window, and wherein the first sheet of transparent material is affixed to an exterior of the first cut-out window and disposed between the fourth panel and the third panel, and the second sheet of transparent material is affixed to an interior of the second cut-out window and disposed between the fourth panel and the third panel,
a card disposable within the pocket, wherein the card is visible through either the first cut-out window and first sheet of transparent material or the second cut-out window and the second sheet of transparent material when the card holding assembly is in the open position, and wherein the first panel conceals the card when the card holding assembly is in the closed position.

16. The blank for card holding assembly of claim 15 wherein the cut-out window is in the center of the third panel.

17. The blank for card holding assembly of claim 15 wherein the pocket is provided for receiving the card in a lengthwise direction.

18. The blank for card holding assembly of claim 15 wherein the card is a gift card.

19. A method of forming a card holding assembly comprising:
providing a blank;
scoring the blank at a first predetermined location to form a first score line, the first predetermined location being a first distance from an end of the blank;
scoring the blank at a second predetermined location to form a second score line, the second predetermined location being a second distance from the first predetermined location;
scoring the blank at a third predetermined location to form a third score line, the third predetermined location being the first distance from the second predetermined location;
scoring the blank at a fourth predetermined location to form a fourth score line, the fourth predetermined location being approximately half of the second distance from the third predetermined location;
forming a card holding assembly from scored blank, the card holding assembly comprising:
a substantially continuous and uninterrupted first panel;
a substantially continuous and uninterrupted second panel separated from the first panel by the first score line and the second score line disposed adjacent a top portion of the second panel, wherein the first and the second panels are of substantially the same dimensions;
a third panel separated from the second panel by the third score line and the fourth score line disposed adjacent a bottom portion of the second panel, the third panel comprising a cut-out window, wherein the third panel and the second panel are coupled to form a pocket provided for receiving a card; and
printing at least one of a text or an image on at least one surface of the first panel.

20. The method of claim 19 further comprising:
folding the first panel over the second panel along a thickness defined by the first and the second score lines; and
folding the third panel over the second panel along a thickness defined by the third and the fourth score lines.

21. The method of claim 19 wherein the second panel is coupled to the third panel by an adhesive strip.

22. The method of claim 19 wherein the second panel is hinged to the third panel.

23. A card holding assembly formed from a single sheet of material and having an open position and a closed position, the card holding assembly comprising:
a substantially continuous and uninterrupted first sheet having a first length and a first width; and
a second sheet having a first layer and a second layer, wherein the first layer is substantially continuous and uninterrupted and has a second length, a second width and a top portion, wherein the second length and the second width are substantially the same as the first length and the first width, wherein the second sheet is separated from the first sheet by a first score line and a second score line disposed adjacent the top portion of the first layer, wherein the second layer has a third length and a third width and the second layer comprises a cut-out window and a transparent material covering the cut-out window, wherein the third length is less than the second length; wherein the first and second layers are adhered to each other on at least two sides to form a pocket, and wherein the first sheet is selectively foldable over the pocket to form the closed position of the card holding assembly.
